(19) United States
(12) Patent Application Publication
(10) Pub. No.: US 2022/0313390 A1
(43) Pub. Date: Oct. 6, 2022

(54) METHOD TO MOUNT CERAMIC VENEERS WITHOUT TOOTH FACING

(71) Applicant: Artavazd Genrikovich MANUKYAN, (RU)

(72) Inventor: Artavazd Genrikovich MANUKYAN, (RU)

(21) Appl. No.: 17/617,933

(22) PCT Filed: Feb. 5, 2021
(86) PCT No.: PCT/RU2021/000049

§ 371 Date: Dec. 10, 2021

(30) Foreign Application Priority Data
Feb. 13, 2020 (RU) 2020106828

(51) Int. Cl. A61C 5/30; A61C 5/20

(52) U.S. Cl. CPC A61C 5/30; A61C 5/20; A61C 2201/00

(57) ABSTRACT

The invention relates to the field of medicine, namely dentistry, and can be used for dental rebuilding without tooth facing. The technical result lies in improving the fixation strength of ceramic veneers without tooth facing. This result is achieved in the method of mounting ceramic veneers comprising surface preparation of at least one veneer, surface preparation of at least one tooth and their coupling using light-cured adhesive cement by means of sandblasting of the tooth surface during its preparation with aluminum oxide powder Al2O3, etching by orthophosphoric acid for 15-30 seconds followed by washing and drying, surface treatment with adhesive for 15-20 seconds, application of a bonding agent, and by means of veneer surface etching with hydrofluoric acid during its preparation followed by treatment with a ceramic primer for one minute and application of a bonding agent on the surface.

The invention relates to the field of medicine, namely dentistry, and can be used for dental rebuilding without tooth facing.

The state of the art provides a method to mount ceramic veneers without tooth facing (U.S. Pat. No. 4,632,660 A, 30 Dec. 1986) comprising surface preparation of at least one veneer, surface preparation of at least one tooth and their coupling using light-cured adhesive cement. Veneer surface preparation comprises its immersion into a bath with 12% hydrofluoric acid for etching for 12-15 minutes. Tooth surface preparation comprises its etching with 30-40% phosphoric acid. This method requires long-term veneer soaking in hydrofluoric acid and does not provide for sufficient strength of veneer fixation since the tooth surface is prepared only using phosphoric acid. This solution is selected as a prototype.

This invention is intended to eliminate the prototype disadvantages.

The technical result lies in improving the fixation strength of ceramic veneers without tooth facing.

This result is achieved in the method of mounting ceramic veneers comprising surface preparation of at least one veneer, surface preparation of at least one tooth and their coupling using light-cured adhesive cement by means of sandblasting of the tooth surface during its preparation with aluminum oxide powder Al2O3, etching by orthophosphoric acid for 15-30 seconds followed by washing and drying, surface treatment with adhesive for 15-20 seconds, application of a bonding agent, and by means of veneer surface etching with hydrofluoric acid during its preparation followed by treatment with a ceramic primer for one minute and application of a bonding agent on the surface.

For sandblasting, aluminum oxide powder Al2O3 with particle size 27 nm is used.

9.5% hydrofluoric acid is preferably used.

37% orthophosphoric acid is preferably used.

Adhesive cement is applied on the veneer and/or tooth surface, then the veneer is mounted and the bonding agent and adhesive cement are light cured.

Light curing is done with a polymerization lamp with the light flux power of at least 500 mW/cm2.

As a rule, the tooth surface preparation includes rubber dam isolation.

The claimed technical result is achieved by undertaking the above actions in the indicated order for veneer and tooth surface preparation.

The method to mount ceramic veneers without tooth facing comprises surface preparation of at least one tooth when, according to the preferable embodiment, the surface is initially isolated from the mouth cavity using a rubber dam followed by sandblasting of the tooth surface using aluminum oxide powder Al2O3 whereas usually particles about 27 μm are used, which is optimal since a large particle size leads to tooth surface damage. The next step is surface etching to 15-30 seconds with orthophosphoric acid such as Total Etch (Ivoclar Vivadent), preferably 37% concentration, then the acid is fully washed with distilled water usually for the same period as etching, and the surface is dried. Then it is treated for 15-20 minutes with an adhesive such as Syntac Adhesive and then a thin layer of bonding agent such as Heliobond (Ivoclar Vivadent) is applied.

The method also comprises surface preparation of at least one veneer when etching is done for one minute using hydrofluoric acid, for example, with Porcelain Etchant (Bisco). Using 9.5% hydrofluoric acid is the most optimal for one-minute etching. Then the veneer surface is treated for one minute with a ceramic primer silane, such as Monobond N, and a thin layer of a bonding agent such as Heliobond (Ivoclar Vivadent) is applied on the surface.

In the case of applying an excessive bonding agent on the surface, air purging is provided until a thin layer is formed.

The last stage of the method is coupling the surface of at least one veneer with the surface of at least one tooth using light-cured adhesive cement such as Variolink Esthetic LC that is applied on the tooth and/or veneer surface. After veneer mounting on the tooth, the bonding agent and adhesive cement are exposed to a polymerization lamp with a light flux power of at least 500 mW/cm2 for about two seconds. The excessive bonded material is removed, and final exposure is done for 10 seconds on the veneer side and tooth side (on the back side).

Only the combination of the described operations using the specified substances helps achieving an improved fixation strength of the ceramic veneer to the tooth without tooth facing.

The invention uses veneers made in a dental laboratory as follows.

Two pickup impressions are made on the upper and lower jaws, the occlusion is recorded and face bow readings are taken. Information is transmitted to the laboratory for manufacturing a teeth gypsum model.

The necessary number of teeth is wax modeled by applying wax on the front surface of the gypsum model of teeth and a new mold is obtained. The model is fitted over the teeth. The model is evaluated upon its length and color and approved by the client.

Retraction is done and two silicone impressions are made by sandwich method, and the occlusion is recorded again.

The obtained information is transmitted to the laboratory for manufacturing at least one veneer.

It should be noted that these temporary gaps do not have to be absolutely complied with. Obviously, small errors in these actions are permitted, for example, an error of about 1 second is permitted for 15-30-second etching with orthophosphoric acid and 15-20 etching with adhesive. For one-minute etching with hydrofluoric acid and one-minute treatment with a ceramic primer, an error of 1-2 seconds is permitted.

The proposed solution has been multiply tested. All the claimed requirements are confirmed.

In this manner, using the proposed invention allows improving the fixation strength of ceramic veneers without tooth facing.

What is claimed is:

1. The method of mounting ceramic veneers comprising surface preparation of at least one veneer, surface preparation of at least one tooth and their coupling using light-cured adhesive cement characterized in that sandblasting of the tooth surface is done during its preparation with aluminum oxide powder Al₂O₃, then etching is done by orthophosphoric acid for 15-30 seconds followed by washing and drying, surface treatment with adhesive for 15-20 seconds, application of a bonding agent, and that veneer surface etching is done with hydrofluoric acid during its preparation followed by treatment with a ceramic primer for one minute and application of a bonding agent on the surface.

2. The method according to claim 1, characterized in that aluminum oxide powder Al₂O₃ with particle size 27 μm is used for sandblasting.

3. The method according to claim 1, characterized in that 9.5% hydrofluoric acid is used.

4. The method according to claim 1, characterized in that 37% orthophosphoric acid is used.

5. The method according to claim 1, characterized in that adhesive cement is applied on the veneer and/or tooth surface, then the veneer is mounted and the bonding agent and adhesive cement are light cured.

6. The method according to claim 15, characterized in that light curing is done with a polymerization lamp with the light flux power of at least 500 mW/cm².

7. The method according to claim 1, characterized in that tooth surface preparation comprises rubber dam isolation.
